(19) United States
(12) Patent Application Publication
(10) Pub. No.: US 2013/0148179 A1
(43) Pub. Date: Jun. 13, 2013

(54) HOLOGRAPHIC DISPLAY

(71) Applicants: Ron Fridental, Shoham (IL); Ilya Blayvas, Ramat Gan (IL)

(72) Inventors: Ron Fridental, Shoham (IL); Ilya Blayvas, Ramat Gan (IL)

(73) Assignee: BROADCOM CORPORATION, Irvine, CA (US)

(21) Appl. No.: 13/314,290

(22) Filed: Dec. 8, 2011

(51) Int. Cl. G03H 1/08

(52) U.S. Cl. 359/9

(57) ABSTRACT

Disclosed are various embodiments of a holographic display device that may reproduce dynamic color holograms and holographic video. A holographic display device includes a processor, a memory, a display screen, and one or more monochromatic light sources. The memory stores a holographic interference pattern that encodes a three-dimensional scene. The display screen is configured by the processor to render the holographic interference pattern. The monochromatic light sources are configured to illuminate the display screen so as to reconstruct a wavefront reflected by the three-dimensional scene.

### BACKGROUND

Holography is a technique that allows for the light scattered from an object to be recorded and later reconstructed. When the light beam is reconstructed and viewed by an observer, an image of the object is seen, though the object is no longer present. The perceived image of the object changes as the position and orientation of the observer changes, in the same way as if the object were present. This makes the image appear to be three-dimensional. The effect of viewing a hologram of an object is similar to that of viewing the object through a window.

Conventional holograms are statically recorded on a holographic medium. For example, a flash of light may illuminate an object, which then imprints on a photographic plate or other medium. The light source for a hologram, unlike with a photograph, is a coherent light source, such as that produced by a laser.

FIG. 1A illustrates a conventional system 100 for recording a hologram. The system 100 includes a light beam 103 generated by a laser or other coherent light source. The light beam 103 is split into an illumination beam 106 and a reference beam 109 by a beam splitter 112. A mirror 115 is used to reflect the reference beam 109 to the photographic plate 118. The illumination beam 106 illuminates a target object 121, and some of that light is reflected onto the photographic plate 118 as the object beam 124.

On the photographic plate, the light waves of the reference beam 109 and the object beam 124 superimpose with each other, and the resulting interference pattern is what is recorded on the photographic plate 118. The interference pattern itself is seemingly random, as this pattern represents the way in which the object beam 124 interfered with the reference beam 109, but not the image of the target object 121 itself. The interference pattern can be said to be an encoded version of the target object 121, requiring a particular key, that is, the original reference beam 109, in order to view its contents. This reconstructing key is provided later by projecting an identical light source onto the developed film, which then recreates a range of the original light reflected by the target object 121.

FIG. 1B illustrates a conventional system 130 for rendering a hologram for view. In FIG. 1B, a reconstruction beam 133 that reproduces the original reference beam 109 illuminates the photographic plate 118. Through diffraction, this produces a reconstructed wavefront 136, which gives the effect of a virtual image 139 of the target object 121 (FIG. 1A) being illuminated by a virtual beam 142. The virtual image 139 is depicted in FIG. 1B with a dashed line to show that the virtual image 139 is a virtual representation of the target object 121. An observer of the reconstructed wavefront 136 would see the original image of the target object 121.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1A is a drawing of a conventional system for recording a hologram.

FIG. 1B is a drawing of a conventional system for rendering a hologram for view.

FIG. 2 is a block diagram that provides one example illustration of a holographic display device according to various embodiments of the present disclosure.

FIG. 3 is a drawing of an exemplary arrangement of a display screen and a plurality of lasers employed in the holographic display screen of FIG. 2 according to one embodiment of the present disclosure.

FIG. 4 is a drawing of a networked environment according to various embodiments of the present disclosure.

FIG. 5 is a flowchart illustrating one example of functionality implemented in the holographic processor in the holographic display device of FIG. 2 according to various embodiments of the present disclosure.

FIG. 6 is a schematic block diagram that provides one example illustration of a computing device employed in the networked environment of FIG. 4 according to various embodiments of the present disclosure.

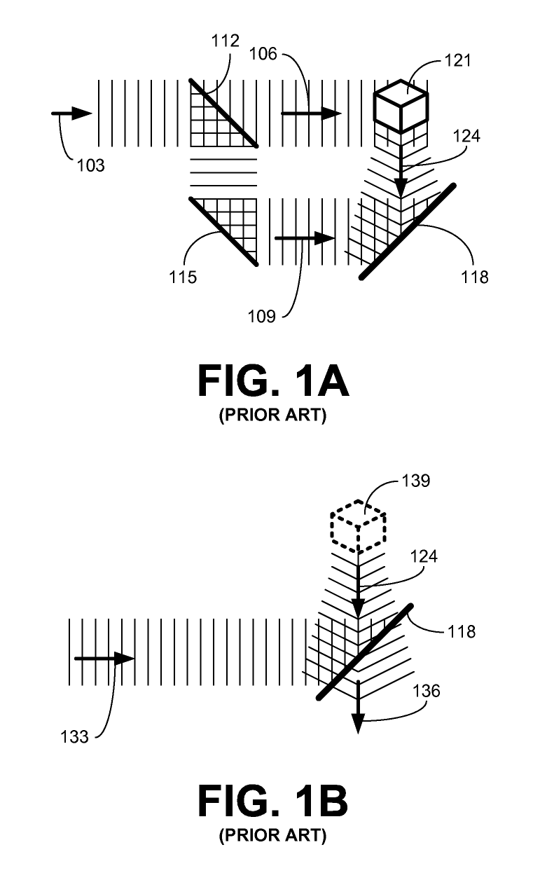

### DETAILED DESCRIPTION

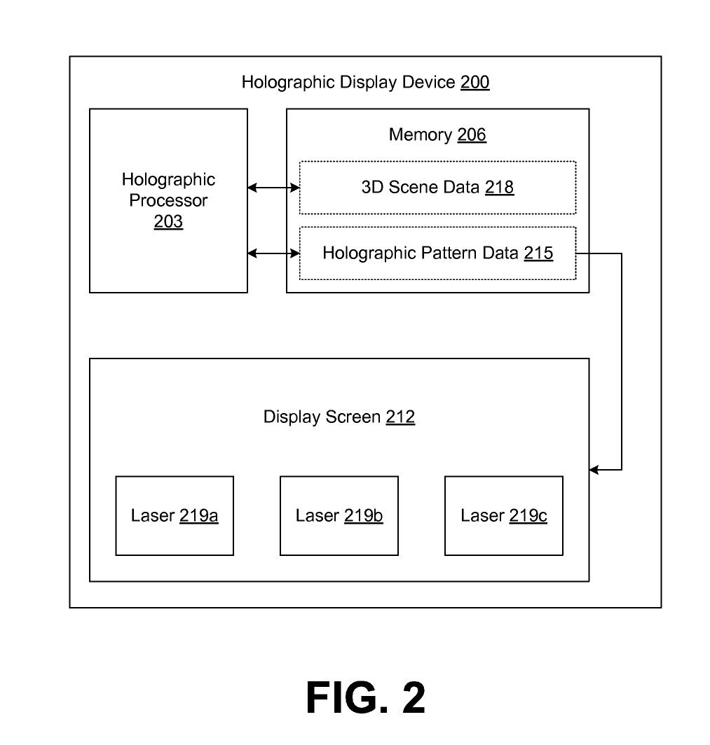

FIG. 2 depicts a holographic display device 200 according to various embodiments of the present disclosure. In the following discussion, a general description of the holographic display device 200 and its components is provided, followed by a discussion of the operation of the same. The holographic display device 200 may be capable of creating holograms dynamically in real-time. Such holograms may correspond to various hologram images of static scenes or holographic video of dynamic scenes. The source material for the holographic display device 200 may, for example, correspond to three-dimensional models, such as those employed for video games or animated movies, or any three-dimensional video stream. In some cases, such models may be generated from stereoscopic video, commonly referred to as 3D movies or television. Additionally, the source material may correspond to holographic interference patterns digitally captured and encoded from a real scene.

The holographic display device 200 may be included as part of a mobile or fixed multi-purpose computing device such as, for example, smartphone, tablet computer, television, desktop computer, laptop computer, video game handheld, and/or other computing devices which may also be general-purpose display devices. Alternatively, the holographic display device 200 may correspond to a special-purpose display device.

The holographic display device 200 includes a holographic processor 203 that may be coupled to a memory 206 and a display screen 212. The holographic processor 203 includes logic that generates holograms that are rendered by the display screen 212. The holographic processor 203 may correspond to a processing device such as, for example, a central processing unit (CPU), a graphics processing unit (GPU), and/or other processing device that may be configured to load program logic from the memory 206 to perform the processing described herein. In some embodiments, the holographic processor 203 may include or correspond to a specialized processing device such as, for example, an application-specific integrated circuit (ASIC), a field-programmable gate array (FPGA), and/or other specialized processing device.

The memory 206 is defined herein as including volatile and/or nonvolatile memory and data storage components. Volatile components are those that do not retain data values upon loss of power. Nonvolatile components are those that retain data upon a loss of power. Thus, the memory 206 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. In various embodiments, the holographic processor 203 and at least a portion of the memory 206 may be integrated such as, for example, with a system on a chip (SoC).

The memory 206 may various data including, for example, holographic pattern data 215, 3D scene data 218, programs for execution by the holographic processor 203 to accomplish the functions described herein, and/or other data. The holographic pattern data 215 corresponds to three-dimensional scenes which have already been encoded for rendering as holograms on the display screen 212. In one embodiment, all or some of the holographic pattern data 215 may be stored in a buffer that is directly coupled to the display screen 212. The 3D scene data 218 corresponds to 3D models, a stereoscopic video stream, a video stream, output from a 3D rendering application programming interface (API) such as OpenGL, Direct3D, or another API, and/or other data defining three-dimensional scenes. In some embodiments, the holographic pattern data 215 and/or the 3D scene data 218 may be loaded from removable storage media by a storage device of the holographic display device 200.

One or more lasers 219 may be employed to illuminate the display screen 212. Each laser 219 produces a monochromatic wavelength of light. In one embodiment, a single laser 219 is used, which produces a single-color hologram on the display screen 212. In other embodiments, multiple lasers 219 may be used. For example, a red laser 219a, a green laser 219b, and a blue laser 219c may be used to illuminate the display screen 212 to render a full-color dynamic hologram. Each laser 219 may correspond to a diode laser or another type of laser. In some embodiments, multiple lasers 219 of each of multiple wavelengths may be used. In one embodiment, the lasers 219 are continuously employed at the same power level to uniformly illuminate the display screen 212. This facilitates a simultaneous display of a superposition of holographic patterns for all three colors. In another embodiment, the lasers 219 are sequentially interchanged in time, with a synchronous display of a corresponding holographic pattern for the active color by the display screen 212.

The display screen 212, which corresponds to a diffraction pattern holographic display screen, is used to render an interference pattern for rear illumination by the lasers 219. The interference pattern may correspond to a single composite interference pattern, or one or more respective interference patterns for each of the wavelengths used by the lasers 219. When the display screen 212 is illuminated by the lasers 219, a wavefront of the three-dimensional scene is reconstructed and is viewable to an observer as a hologram.

The display screen 212 is a high resolution display based on liquid crystal display technology, piezo-electric technology, electro-chemical technology, or technology employing other light obscuring, light bending, or light phasing principles. The display screen 212 corresponds to an array of pixels that may be enabled or disabled by the holographic processor 203. Where multiple color lasers 219 are employed, each pixel may include respective components that selectively permit the corresponding wavelengths of light emitted by the lasers 219 to pass through the screen. For example, the display screen 212 may generate the holographic patterns with Fresnel micro-lenses over each corresponding color pixel.

The display screen 212 may also be used as a conventional color display with exceptionally high resolution, color saturation, and/or other characteristics that make it suitable for rendering holographic patterns as described. Thus, the display screen 212 may be configured to render a conventional two-dimensional image of pixels, e.g., a 1920×1080 image or another resolution of two-dimensional image. In this embodiment, the patterns of Fresnel microlenses may be created in the respective positions of the pixels. The display screen 212 may be used also as a light directing or light projecting device. Generation of diffraction patterns by Fresnel lenses on the screen may create optical properties of the optical lens, while other specific diffraction patterns may have light directing properties.

Next, a general description of the operation of the various components of the holographic display device 200 is provided. To begin, the holographic processor 203 may obtain 3D scene data 218. Such data may be generated from models such as polygonal meshes, volumetric voxel models, and so on. A program such as a game application, a virtual reality application, and so on may be used to generate the three-dimensional scene. In some cases, the 3D scene data 318 may be generated from stereoscopic scenes such as stereoscopic video.

From the 3D scene data 218, the holographic processor 203 generates holographic pattern data 215. The holographic processor 203 employs ray tracing or other approaches to determine how light from the lasers 219 would interfere with light from the lasers 219 reflected by the 3D scene at a virtual display screen 212. To this end, the holographic processor 203 takes into account the wavelengths of the lasers 219 and the various angles at which the 3D scene is illuminated virtually. The holographic interference pattern is generated and may be stored in the holographic pattern data 215.

Depending on the complexity of the processing, generation of the holographic pattern data 215 may be performed in real-time or in advance. In one embodiment, the holographic pattern data 215 is optically captured from a real three-dimensional scene and digitized.

The holographic processor 203 then renders the holographic interference pattern on the display screen 212. The display screen 212 is back-illuminated by the lasers 219, thereby reconstructing a wavefront corresponding to light reflected by the virtual three-dimensional scene. The holographic interference pattern may correspond to one frame from a holographic video stream. The holographic interference pattern may be regenerated at a frame rate, thereby recreating motion in the three-dimensional scene.

In contrast to the display of ordinary video, frames of holographic video may not employ progressive scan, interlaced scan, etc. because the entirety of the holographic interference pattern may be necessary to reproduce the wavefront. In various embodiments, the entire holographic interference pattern is changed at the same moment, with the lasers 219 being switched off during the change of pattern.

In one embodiment, time-separation of colors is employed. As a non-limiting example, at 30 frames per second (33 milliseconds per frame), the red portion of the pattern may be shown for 10 milliseconds, the green portion of the pattern may be shown for 10 milliseconds, and the blue portion of the pattern may be shown for 10 milliseconds.

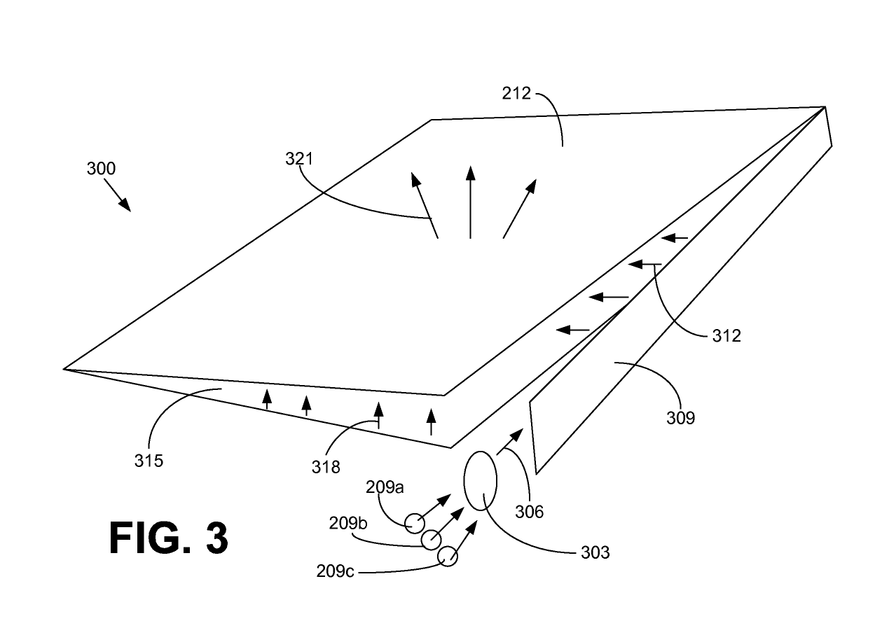

FIG. 3 depicts an exemplary arrangement 300 of the lasers 219 and the display screen 212 used in the holographic display device 200 (FIG. 2) according to one embodiment. Light emitted by the lasers 219a, 219b, and 219c is focused by one or more optical lenses 303 to form appropriate laser light beams 306. The laser light beams 306 are then reflected by a first mirror 309 to produce a first light plane 312. The first light plane 312 is then reflected by a second mirror 315 to produce a second light plane 318.

The second light plane 318 uniformly illuminates the display screen 212. The display screen 212 dynamically renders a holographic pattern according to a light obscuring, light bending, or light phasing principle. The holographic pattern rendered by the display screen 212 allows a reconstructed wavefront 321 to pass through the display screen 212. This reconstructed wavefront 321 corresponds to light that appears to be reflected by a virtual three-dimensional scene.

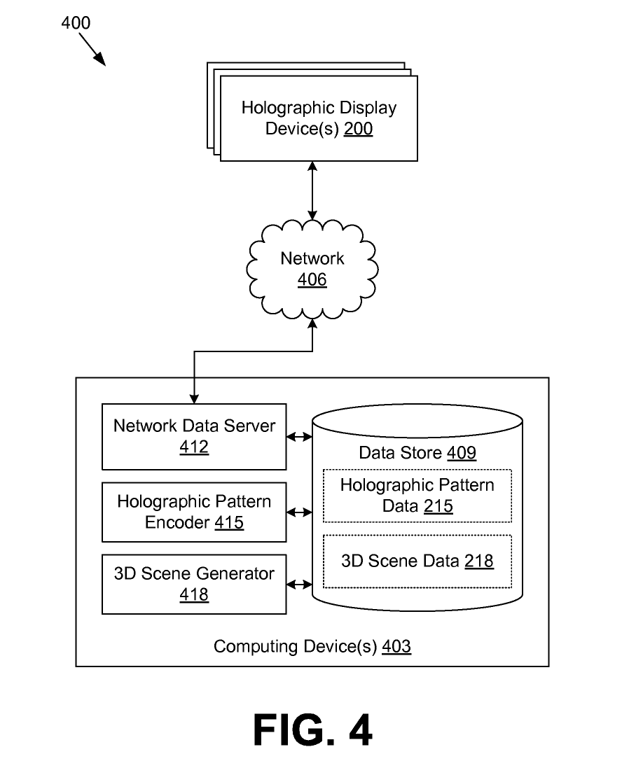

With reference to FIG. 4, shown is a networked environment 400 according to various embodiments. The networked environment 400 includes one or more holographic display devices 200 in data communication with one or more computing devices 403 by way of a network 406. The network 406 includes, for example, the Internet, intranets, extranets, wide area networks (WANs), local area networks (LANs), wired networks, wireless networks, or other suitable networks, etc., or any combination of two or more such networks.

The computing device 403 may comprise, for example, a server computer or any other system providing computing capability. Alternatively, a plurality of computing devices 403 may be employed that are arranged, for example, in one or more server banks or computer banks or other arrangements. For example, a plurality of computing devices 403 together may comprise a cloud computing resource, a grid computing resource, and/or any other distributed computing arrangement. Such computing devices 403 may be located in a single installation or may be distributed among many different geographical locations. For purposes of convenience, the computing device 403 is referred to herein in the singular. Even though the computing device 403 is referred to in the singular, it is understood that a plurality of computing devices 403 may be employed in the various arrangements as described above.

Various applications and/or other functionality may be executed in the computing device 403 according to various embodiments. Also, various data is stored in a data store 409 that is accessible to the computing device 403. The data store 409 may be representative of a plurality of data stores 409 as can be appreciated. The data stored in the data store 409 includes, for example, holographic pattern data 215, 3D scene data 218, and potentially other data. The data stored in the data store 409, for example, is associated with the operation of the various applications and/or functional entities described below.

The components executed on the computing device 403, for example, include a network data server 412, a holographic pattern encoder 415, a 3D scene generator 418, and other applications, services, processes, systems, engines, or functionality not discussed in detail herein. The network data server 412 is executed to serve up the holographic pattern data 215 and/or the 3D scene data 218 to the holographic display device 200 over the network 406 in response to a request from the holographic display device 200. In various embodiments, the network data server 412 may correspond to a hypertext transfer protocol (HTTP) server, a real-time protocol (RTP) media server, and/or another type of server application.

The 3D scene generator 418 may be executed to generate the 3D scene data 218, while the holographic pattern encoder 415 may be executed to encode the 3D scene data 218 into the holographic pattern data 215. In other words, a distributed architecture may be employed so as to off-load at least a portion of the processing and encoding functionality from the holographic processor 203 (FIG. 2) of the holographic display device 200 to computing devices 403 with greater processing and/or memory capacity. Assuming availability of a high-bandwidth connection to the network 406, the holographic display device 200 may be manufactured with less processing and/or memory capacity to reduce cost.

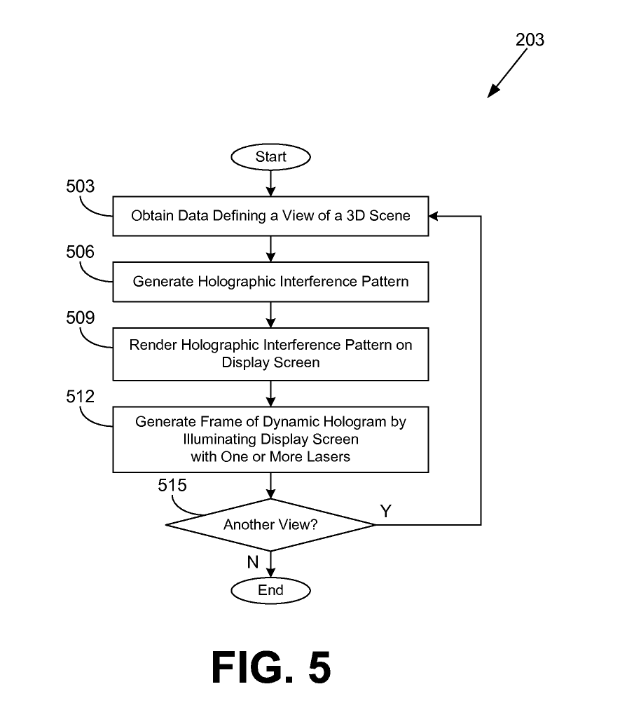

Referring next to FIG. 5, shown is a flowchart that provides one example of the operation of the holographic processor 203 according to various embodiments. It is understood that the flowchart of FIG. 5 provides merely an example of the many different types of functional arrangements that may be employed to implement the operation of the holographic processor 203 as described herein.

Beginning with box 503, the holographic processor 203 may obtain data defining a view of a three-dimensional scene. Such data may be stored in the 3D scene data 218 or obtained over a network 406 (FIG. 4) from another computing device 403 (FIG. 4). In box 506, the holographic processor 203 generates a holographic interference pattern. The holographic interference pattern may be generated based at least in part on the data defining the view of the three-dimensional scene. The holographic interference pattern may also be generated based at least in part on a physical characteristic of the holographic display device 200 (FIG. 2), such as the arrangement of lasers 219 (FIG. 2) and mirrors and/or other physical characteristics. In some examples, the holographic interference pattern may be previously generated and stored in the holographic pattern data 215 or on a removable storage medium. In some embodiments, the holographic interference pattern may be obtained over a network 406 from another computing device 403.

In box 509, the holographic processor 203 renders the holographic interference pattern on the display screen 212 (FIG. 2). In box 512, the holographic processor 203 generates a frame of a dynamic hologram by illuminating the display screen 212 with one or more lasers 219. In one embodiment, the lasers 219 are sequentially switched on and off, with the respective portion of the holographic interference pattern that corresponds to the respective color of the active laser 219 being displayed on the display screen 219. In this way, holograms of primary colors (such as, for example, red, green, and blue) may be separated in time to create a user perception of a color hologram with general half-tone colors.

In box 515, the holographic processor 203 determines whether another view of the three-dimensional scene or another three-dimensional scene is to be processed. If another view is to be processed for the dynamic hologram, the holographic processor 203 returns to box 503. Otherwise, the operation of the holographic processor 203 ends.

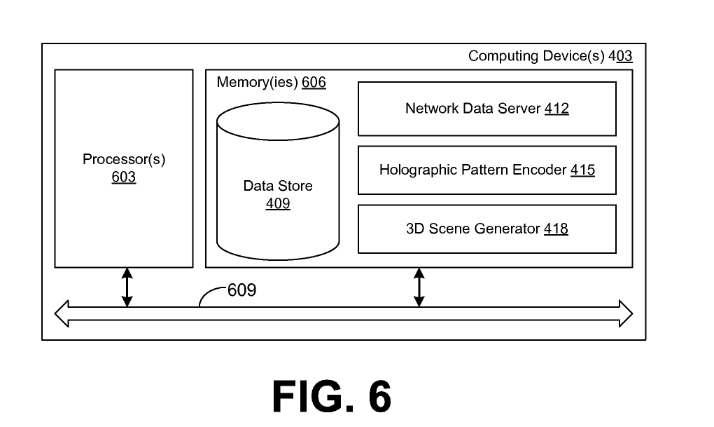

With reference to FIG. 6, shown is a schematic block diagram of the computing device 403 according to an embodiment of the present disclosure. The computing device 403 includes at least one processor circuit, for example, having a processor 603 and a memory 606, both of which are coupled to a local interface 609. To this end, the computing device 403 may comprise, for example, at least one server computer or like device. The local interface 609 may comprise, for example, a data bus with an accompanying address/control bus or other bus structure as can be appreciated.

Stored in the memory 606 are both data and several components that are executable by the processor 603. In particular, stored in the memory 606 and executable by the processor 603 are the network data server 412, the holographic pattern encoder 415, the 3D scene generator 418, and potentially other applications. Also stored in the memory 606 may be a data store 409 and other data. In addition, an operating system may be stored in the memory 606 and executable by the processor 603.

It is understood that there may be other applications that are stored in the memory 606 and are executable by the processor 603 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 606 and are executable by the processor 603. In this respect, the term “executable” means a program file that is in a form that can ultimately be run by the processor 603. Examples of executable programs may be, for example, a compiled program that can be translated into machine code in a format that can be loaded into a random access portion of the memory 606 and run by the processor 603, source code that may be expressed in proper format such as object code that is capable of being loaded into a random access portion of the memory 606 and executed by the processor 603, or source code that may be interpreted by another executable program to generate instructions in a random access portion of the memory 606 to be executed by the processor 603, etc. An executable program may be stored in any portion or component of the memory 606 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 606 is defined herein as including both volatile and nonvolatile memory and data storage components. Volatile components are those that do not retain data values upon loss of power. Nonvolatile components are those that retain data upon a loss of power. Thus, the memory 606 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 603 may represent multiple processors 603 and the memory 606 may represent multiple memories 606 that operate in parallel processing circuits, respectively. In such a case, the local interface 609 may be an appropriate network that facilitates communication between any two of the multiple processors 603, between any processor 603 and any of the memories 606, or between any two of the memories 606, etc. The local interface 609 may comprise additional systems designed to coordinate this communication, including, for example, performing load balancing. The processor 603 may be of electrical or of some other available construction.

Likewise, the holographic processor 203 (FIG. 2) may represent multiple holographic processors 203 and the memory 206 (FIG. 2) may represent multiple memories 206 that operate in parallel processing circuits, respectively. In such a case, a local interface may be employed that facilitates communication between any two of the multiple holographic processors 203, between any holographic processors 203 and any of the memories 206, or between any two of the memories 206, etc. The local interface may comprise additional systems designed to coordinate this communication, including, for example, performing load balancing. The holographic processor 203 may be of electrical or of some other available construction.

Although the network data server 412, the holographic pattern encoder 415, the 3D scene generator 418, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 5 shows the functionality and operation of an implementation of portions of the holographic processor 203. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowchart of FIG. 5 shows a specific order of execution, it is understood that the order of execution may differ from that which is depicted. For example, the order of execution of two or more blocks may be scrambled relative to the order shown. Also, two or more blocks shown in succession in FIG. 5 may be executed concurrently or with partial concurrence. Further, in some embodiments, one or more of the blocks shown in FIG. 5 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the network data server 412, the holographic pattern encoder 415, the 3D scene generator 418, and the holographic processor 203, that comprises software or code can be embodied in any non-transitory computer-readable medium for use by or in connection with an instruction execution system such as, for example, a processor 603 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A holographic display device, comprising:
a processor;
a memory storing a holographic interference pattern that encodes a three-dimensional scene;
a display screen configured by the processor to render the holographic interference pattern; and
at least one monochromatic light source configured to illuminate the display screen rendering the holographic interference pattern so as to reconstruct a wavefront reflected by the three-dimensional scene.

2. The holographic display device of claim 1, wherein the processor is configured to generate the holographic interference pattern from data that models the three-dimensional scene.

3. The holographic display device of claim 2, wherein the processor is a specialized processor.

4. The holographic display device of claim 2, wherein the processor is a general-purpose processor executing a program that generates the holographic interference pattern.

5. The holographic display device of claim 1, wherein the holographic interference pattern corresponds to a video frame of a holographic video stream.

6. The holographic display device of claim 1, wherein the at least one monochromatic light source comprises a red monochromatic light source, a green monochromatic light source, and a blue monochromatic light source, and the display screen is a red-green-blue display screen.

7. The holographic display device of claim 1, wherein the at least one monochromatic light source comprises a diode laser.

8. The holographic display device of claim 1, wherein the holographic interference pattern is loaded from a removable storage medium.

9. The holographic display device of claim 1, wherein the holographic display device is included in a multi-purpose computing device.

10. A system, comprising:
at least one computing device;
at least one program executable in the at least one computing device, the at least one program comprising:
logic that generates a holographic interference pattern from data defining a three-dimensional scene; and
logic that sends the holographic interference pattern to a holographic display device; and
wherein the holographic display device comprises:
a processor configured to obtain the holographic interference pattern from the at least one computing device;
a display screen configured by the processor to render the holographic interference pattern; and
at least one monochromatic light source configured to illuminate the display screen rendering the holographic interference pattern so as to reconstruct a wavefront reflected by the three-dimensional scene.

11. The system of claim 10, wherein the at least one program further comprises logic that generates the data defining the three-dimensional scene based at least in part on a stereoscopic video frame.

12. The system of claim 10, wherein the at least one program further comprises logic that generates the data defining the three-dimensional scene based at least in part on a display output of a game application.

13. The system of claim 10, wherein the at least one monochromatic light source comprises a red monochromatic light source, a green monochromatic light source, and a blue monochromatic light source, and the display screen is a color display screen.

14. A method, comprising the steps of:
obtaining data defining a view of a three-dimensional scene;
generating a holographic interference pattern based at least in part on the data defining the view of the three-dimensional scene and at least one physical characteristic of a holographic display device;
rendering the holographic interference pattern on a display screen of the holographic display device; and
generating a frame of a dynamic hologram by illuminating the display screen with at least one monochromatic light source.

15. The method of claim 14, further comprising the step of generating the data defining the view based at least in part on a stereoscopic video frame.

16. The method of claim 14, further comprising the steps of:
obtaining data defining a subsequent view of the three-dimensional scene;
generating a subsequent holographic interference pattern based at least in part on the data defining the subsequent view of the three-dimensional scene and the at least one physical characteristic of the holographic display device;
rendering the subsequent holographic interference pattern on the display screen; and
generating a subsequent frame of the dynamic hologram by illuminating the display screen with the at least one monochromatic light source.

17. The method of claim 16, wherein the view and the subsequent view correspond to respective frames of a video stream.

18. The method of claim 14, wherein the at least one monochromatic light source comprises a first monochromatic light source and a second monochromatic light source, and the method further comprises the steps of:
rendering a first portion of the holographic interference pattern on the display screen, the first portion corresponding to a first color of the frame;
illuminating the display screen with the first monochromatic light source to show the first color of the frame;
rendering a second portion of the holographic interference pattern on the display screen, the second portion corresponding to a second color of the frame; and
illuminating the display screen with the second monochromatic light source to show the second color of the frame.

19. The method of claim 18, further comprising the step of disabling illumination of the display screen by the first monochromatic light source and the second monochromatic light source for a time period between showing the first color of the frame and showing the second color of the frame.

20. The method of claim 14, wherein the at least one monochromatic light source comprises a red laser, a green laser, and a blue laser, and the display screen is a color display screen.
